(19) United States
(12) Patent Application Publication
(10) Pub. No.: US 2012/0062991 A1
(43) Pub. Date: Mar. 15, 2012

(54) AUTOSTEREOSCOPIC DISPLAY DEVICE

(75) Inventors: Marcellinus Petrus Carolus Mich Krijn, Eindhoven (NL); Siebe T. De Zwart, Eindhoven (NL); Fetze Pulman, Eindhoven (NL); Lieven R.R. Desmet, Eindhoven (NL); Oscar Henricus Willemsen, Eindhoven (NL)

(73) Assignee: KONINKLIJKE PHILIPS ELECTRONICS N.V., EINDHOVEN (NL)

(21) Appl. No.: 13/322,182

(22) PCT Filed: May 7, 2010
(86) PCT No.: PCT/IB10/52023

§ 371 Date: Nov. 23, 2011

(30) Foreign Application Priority Data
May 28, 2009 (EP) 09161330.7
Jun. 26, 2009 (EP) 09163875.9
Apr. 9, 2010 (EP) 10159467.9

(51) Int. Cl. G02B 27/22; G09F 13/04

(52) U.S. Cl. 359/463; 362/97.1

(57) ABSTRACT

An autostereoscopic display device has both a barrier arrangement and a lens arrangement. A plurality of views are provided to different lateral viewing directions. At least a portion of the field of view has autostereoscopic output, and the portion having autostereoscopic output has no repetition of individual 2D views and comprises at least three individual 2D views. This means there is no reversal of the stereo views (“pseudo stereo views”) at viewing cone boundaries as there are no viewing cone boundaries.

### FIELD OF THE INVENTION

This invention relates to an autostereoscopic display device of the type that comprises a display panel having an array of display pixels for producing a display and an imaging arrangement for directing different views to different spatial positions.

### BACKGROUND OF THE INVENTION

A first example of an imaging arrangement for use in this type of display is a barrier, for example with slits that are sized and positioned in relation to the underlying pixels of the display. In a two-view design, the viewer is able to perceive a 3D image if his/her head is at a fixed position. The barrier is positioned in front of the display panel and is designed so that light from the odd and even pixel columns is directed towards the left and right eye of the viewer, respectively.

A drawback of this type of two-view display design is that the viewer has to be at a fixed position, and can only move approximately 3 cm to the left or right. In a more preferred embodiment there are not two sub-pixel columns beneath each slit, but several. In this way, the viewer is allowed to move to the left and right and perceive a stereo image in his/her eyes all the time.

The barrier arrangement is simple to produce but is not light efficient. A preferred alternative is therefore to use a lens arrangement as the imaging arrangement. For example, an array of elongate lenticular elements can be provided extending parallel to one another and overlying the display pixel array, and the display pixels are observed through these lenticular elements.

The lenticular elements are provided as a sheet of elements, each of which comprises an elongate semi-cylindrical lens element. The lenticular elements extend in the column direction of the display panel, with each lenticular element overlying a respective group of two or more adjacent columns of display pixels.

In an arrangement in which, for example, each lenticule is associated with two columns of display pixels, the display pixels in each column provide a vertical slice of a respective two dimensional sub-image. The lenticular sheet directs these two slices and corresponding slices from the display pixel columns associated with the other lenticules, to the left and right eyes of a user positioned in front of the sheet, so that the user observes a single stereoscopic image. The sheet of lenticular elements thus provides a light output directing function.

In other arrangements, each lenticule is associated with a group of four or more adjacent display pixels in the row direction. Corresponding columns of display pixels in each group are arranged appropriately to provide a vertical slice from a respective two dimensional sub-image. As a user's head is moved from left to right, a series of successive, different, stereoscopic views are perceived creating, for example, a look-around impression.

The above described device provides an effective three dimensional display. However, it will be appreciated that, in order to provide stereoscopic views, there is a necessary sacrifice in the horizontal resolution of the device. This sacrifice in resolution increases with the number of views generated. Thus, a major drawback of using a high number of views is that the image resolution per view is reduced. The total number of available pixels has to be distributed among the views. In the case of an n-view 3D display with vertical lenticular lenses, the perceived resolution of each view along the horizontal direction will be reduced by a factor of n relative to the 2D case. In the vertical direction the resolution will remain the same. The use of a barrier or lenticular that is slanted can reduce this disparity between resolution in the horizontal and vertical direction. In that case, the resolution loss can be distributed evenly between the horizontal and vertical directions.

Increasing the number of views thus improves the 3D impression but reduces the image resolution as perceived by the viewer. The individual views are in each so-called viewing cones, and these viewing cones typically repeat across the field of view.

The viewing experience is hampered by the fact that the viewers are not entirely free in choosing their location within the field of view of the display device, i.e. their location from which to view a 3D monitor or television in the sense that at the boundaries between viewing cones within the field of view of the display, the 3D effect is absent and annoying ghost images appear. This invention relates to this problem.

### SUMMARY OF THE INVENTION

One object of the invention is to reduce the number of, and preferably to eliminate the viewing cone boundaries.

The object is achieved by the invention as defined in the independent claims. The dependent claims define advantageous embodiments.

The autostereoscopic device according to the invention combines lenses and barrier openings to enable a wide field of view and with no repetition of views in the autostereoscopic output region. Preferably, the display panel comprises an array of display pixels, and the barrier arrangement is arranged such that light from a pixel reaches only one barrier opening. This prevents individual views being output through multiple barrier openings, and thereby prevents repetition of viewing cones.

The normal direction may preferably be with respect to the display panel.

Pixels can be sub-pixels each having different colors as is usual in the art.

Lateral viewing directions are perpendicular to vertical viewing directions, where vertical has its usual meaning.

The lenses of the lens arrangement can be positioned at the openings of the barrier arrangement. In this case, the radius of each lens arrangement is preferably between 0.2 and 0.5 times the spacing between the barrier arrangement and the display panel.

In one preferred design, all of the field of view has autostereoscopic output. However, in order to reduce the total number of views (and thereby reduce the reduction in resolution), a central portion of the field of view can have autostereoscopic output, and lateral portions of the field of view have 2D output. The individual 2D views of the central portion of the field of view can then be more closely positioned than the 2D views in the lateral portions of the field of view. To achieve this, in one arrangement the lens arrangement can be provided between the display panel and the barrier arrangement, and comprises lenses with different radius of curvature in a central portion than in lateral portions. This variation in curvature enables the normal views to be more densely populated than the lateral views. Additional lens elements can be provided at the openings of the barrier arrangement.

In another arrangement, the barrier arrangement can be provided between the display panel and the lens arrangement, with each lens element receiving all the light from a respective barrier opening.

In this case, the lens elements can have a central portion which receives light only from one barrier opening, and shared edge portions which receive light from two adjacent barrier openings. This enables the lens elements to have a regular or periodic shape, for example a sinusoidal profile. The lens elements can comprise a stack of two lens sub-elements, each having a sinusoidal profile. Again, additional lens elements can be provided at the openings of the barrier arrangement.

In these arrangements, the individual 2D views of the central portion are preferably separated by 0.5 to 3 degrees.

The barrier arrangement can comprise at least one transparent slab, wherein the slab is shaped with a cross section in the shape of a rectangle with cut-outs, wherein the cut-outs are positioned in areas outside the regions to which the light paths between the display panel and the barrier arrangement are limited. This enables the weight of the display device to be reduced.

In an embodiment, the display panel (such as e.g. an LCD display panel) comprises a spatial light modulator and the autostereoscopic display comprises a backlight providing light to the spatial light modulator to pass the spatial light modulator. Preferably, the backlight is a collimated backlight providing collimated light to the spatial light modulator. This provides an improved brightness for the autostereoscopic display as at least some of the otherwise lost light is redirected into the views.

Preferably, the backlight is configured such that the collimated light is parallel or convergent and limited to at least the first range at each side of a direction normal to the display panel. In this way no light of the backlight is lost at all. Preferably the collimated backlight is configured such that it provides collimated light consisting of one or more parallel or converging beams emitted in one single direction. Preferably this direction is perpendicular to the illumination direction of the backlight.

When the autostereoscopic display is configured such that the first range at each side of a direction normal to the display panel is such that a convergent beam leaves the display panel, then the autostereoscopic display may comprise a weaved lens array in between the display panel and the collimating backlight for providing a converging, collimated beam of light to the display panel such that at the plane of the spatial light modulator there are no regions in between neighboring converging beams that are not illuminated by at least one beam.

In this case preferably the backlight provides parallel collimated light over its entire illuminating area. Alternatively, the weaved lens array may be integrated in the backlight to provide the display panel converging beams of light that illuminate the entire display panel area.

Another arrangement further comprises a second barrier arrangement comprising an array of openings, with the said barrier arrangement (which will be referred to as the “first” barrier arrangement) and the second barrier arrangement between the display panel and the lens arrangement. The second barrier arrangement has wider openings than the first barrier arrangement. This double-barrier arrangement enables the pitch between barrier openings of the first barrier arrangement to be reduced further than is possible with a single barrier arrangement. This means the system enables the benefit of high resolution displays to be obtained without needing to bring the first barrier arrangement any closer to the display panel, i.e. without having to reduce the spacing between the first barrier arrangement and the display panel.

For example, for at least some pixels of the display, within the first range of angles the pixel output is projected to at least two barrier openings of the barrier arrangement. This would give a multi-cone output for a single barrier arrangement. However, the second barrier arrangement blocks light such that the light from pixel passes through only one of the second barrier arrangement openings. This restores a single cone output.

### BRIEF DESCRIPTION OF THE DRAWINGS

Embodiments of the invention will now be described, purely by way of example, with reference to the accompanying drawings, in which:

FIG. 1 is a schematic perspective view of a known autostereoscopic display device;

FIG. 2 shows how a lenticular array provides different views to different spatial locations;

FIG. 3 shows how a barrier arrangement provides different views to different spatial locations;

FIG. 4 shows a cross-section of the layout of a multi-view auto-stereoscopic display;

FIG. 5 is a close-up of FIG. 4;

FIG. 6 shows a 9-view system in which the views produced in each of the sets of cones are equal;

FIG. 7 is shows schematically the ideal solution of the problem of the occurrence of repeated cones and cone transitions;

FIG. 8 shows a basic embodiment for a “single cone” display such as shown in FIG. 7;

FIG. 9a shows one possible display design and FIGS. 9b and 9c show two embodiments of the invention;

FIG. 10 shows another embodiment of a display of the invention;

FIG. 11 shows the lens function comparing the prior art with the invention;

FIGS. 12a and 12b show further embodiments in which the lens and the barrier are placed at different distances from the pixel-plane;

FIGS. 13a and 13b show further embodiments with simplified designs for the main lens;

FIGS. 14a and 14b shows further embodiments with increased distance between the barrier and lens arrangements;

FIG. 15 shows an actual design for a 42″ (107 cm) display;

FIG. 16 shows a possible modification to the backlight design;

FIG. 17 shows a further embodiment which enables benefit to be obtained from an increased pixel resolution;

FIG. 18 is used to explain parts of the substrate of the design of FIG. 7 which can be removed in accordance with a further example of the invention;

FIG. 19 shows the design of FIG. 7 with the substrate parts removed;

FIG. 20 shows a modification to the design of FIG. 19;

FIG. 21 is used to explain parts of the second substrate of the design of FIG. 17 which can also be removed in accordance with a further example of the invention; and

FIG. 22 shows the design of FIG. 17 with the second substrate parts removed.

FIG. 23 is a schematic collimating backlight.

FIG. 24 shows an autostereoscopic display device according to the invention having a collimating backlight.

### DETAILED DESCRIPTION OF EMBODIMENTS

The invention provides an autostereoscopic display device having a field of view and in which both a barrier arrangement and a lens arrangement are used. A plurality of views is provided to different lateral viewing directions within the field of view. At least a portion of the field of view has autostereoscopic output (3D), and the portion having autostereoscopic output has no repetition of individual (2D) views. This means there is no reversal of the stereo views (“pseudo stereo views”) at viewing cone boundaries, as there are no viewing cone boundaries.

The problems addressed by the invention will first be described in more detail before an explanation of the invention is provided.

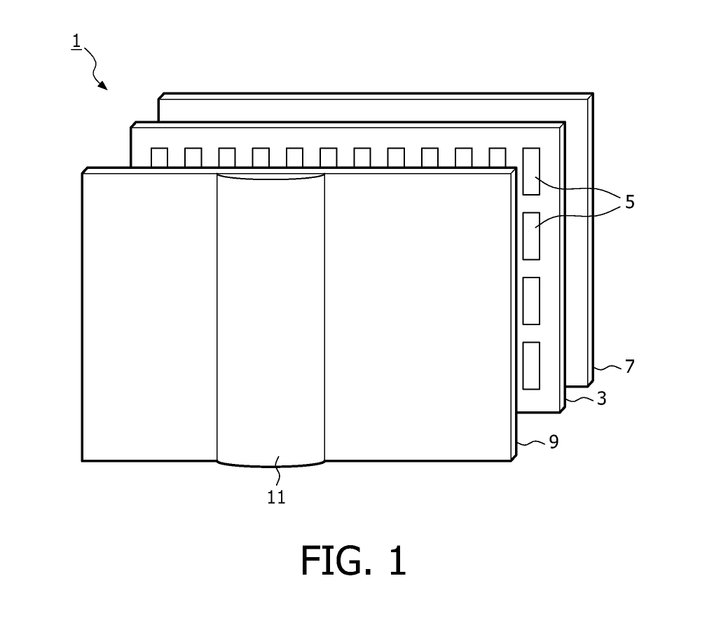

FIG. 1 is a schematic perspective view of a known direct view autostereoscopic display device 1. The known device 1 comprises a liquid crystal display panel 3 of the active matrix type that acts as a spatial light modulator to produce the display.

The display panel 3 has an orthogonal array of display pixels 5 arranged in rows and columns. For the sake of clarity, only a small number of display pixels 5 are shown in the Figure. In practice, the display panel 3 might comprise about one thousand rows and several thousand columns of display pixels 5.

The structure of the liquid crystal display panel 3 is entirely conventional. In particular, the panel 3 comprises a pair of spaced transparent glass substrates, between which an aligned twisted nematic or other liquid crystal material is provided. The substrates carry patterns of transparent indium tin oxide (ITO) electrodes on their facing surfaces. Polarizing layers are also provided on the outer surfaces of the substrates.

Each display pixel 5 comprises opposing electrodes on the substrates, with the intervening liquid crystal material therebetween. The shape and layout of the display pixels 5 are determined by the shape and layout of the electrodes. The display pixels 5 are regularly spaced from one another by gaps.

Each display pixel 5 is associated with a switching element, such as a thin film transistor (TFT) or thin film diode (TFD). The display pixels are operated to produce the display by providing addressing signals to the switching elements, and suitable addressing schemes will be known to those skilled in the art.

The display panel 3 is illuminated by a light source 7 comprising, in this case, a planar backlight extending over the area of the display pixel array. Light from the light source 7 is directed through the display panel 3, with the individual display pixels 5 being driven to modulate the light and produce the display.

The display device 1 also comprises a lenticular sheet 9, arranged over the display side of the display panel 3, which performs a view forming function. The lenticular sheet 9 comprises a row of lenticular elements 11 extending parallel to one another, of which only one is shown with exaggerated dimensions for the sake of clarity.

The lenticular elements 11 are in the form of convex cylindrical lenses, and they act as a light output directing means to provide different images, or views, from the display panel 3 to the eyes of a user positioned in front of the display device 1.

The autostereoscopic display device 1 shown in FIG. 1 is capable of providing several different perspective views in different directions. In particular, each lenticular element 11 overlies a small group of display pixels 5 in each row. The lenticular element 11 projects each display pixel 5 of a group in a different direction, so as to form the several different views. As the user's head moves from left to right, his/her eyes will receive different ones of the several views, in turn.

The skilled person will appreciate that a light polarizing means must be used in conjunction with the above described array, since the liquid crystal material is birefringent, with the refractive index switching only applying to light of a particular polarization. The light polarizing means may be provided as part of the display panel or the imaging arrangement of the device.

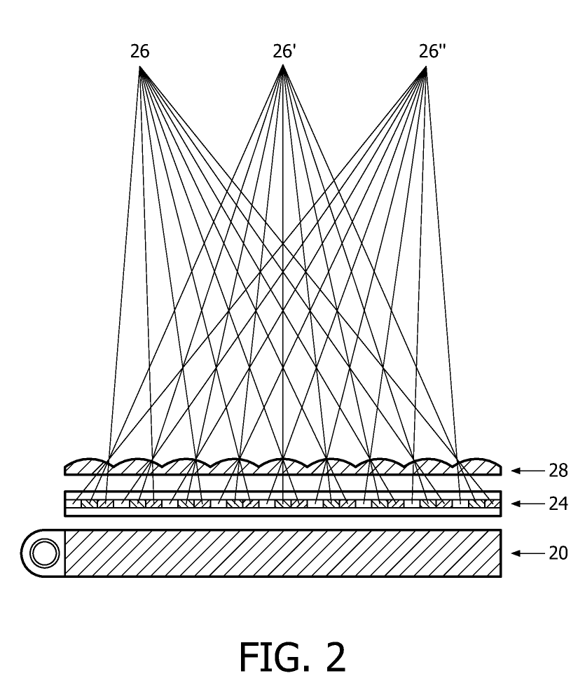

FIG. 2 shows the principle of operation of a lenticular type imaging arrangement as described above and shows the backlight 20, display device 24 such as an LCD and the lenticular array 28. FIG. 2 shows how the lenticular arrangement 28 directs different pixel outputs to three different spatial locations 26, 26′ and 26″. The pixels may be pixels of a monochrome display or, as in the present example (not indicated by reference numerals but evident from pixel shading in the drawing, the sub-pixels of color displays. The rendering of the display, i.e. assignment of sub-pixels to the views generated by the display, will be such that every view has all color image information. Suitable schemes for rendering will be known to those skilled in the art as they have been described in detail in prior art.

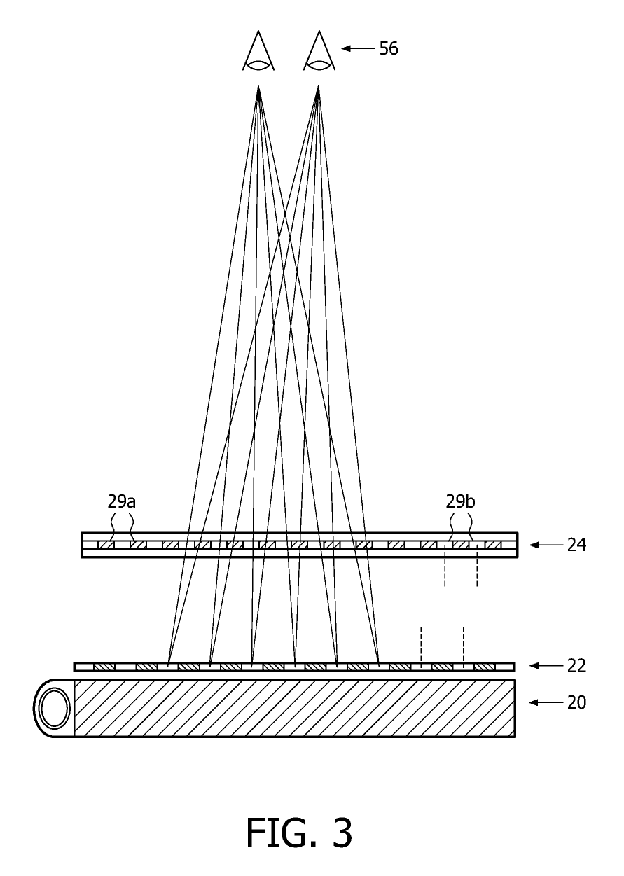

FIG. 3 shows the principle of operation of a barrier type imaging arrangement showing the backlight 20, barrier device 22 and display device 24 such as an LCD. FIG. 3 shows how the barrier device 22 provides a patterned light output. This means that different pixels are illuminated by discontinuous light source regions, with the effect that a light directing function is implemented. As shown, pixels 29a for one view are illuminated from one direction and pixels 29b for another view are illuminated from another direction. The two eyes of the viewer 56 receive light modulated by different pixels of the display.

This invention is concerned with the problem of view repetition, which is explained below.

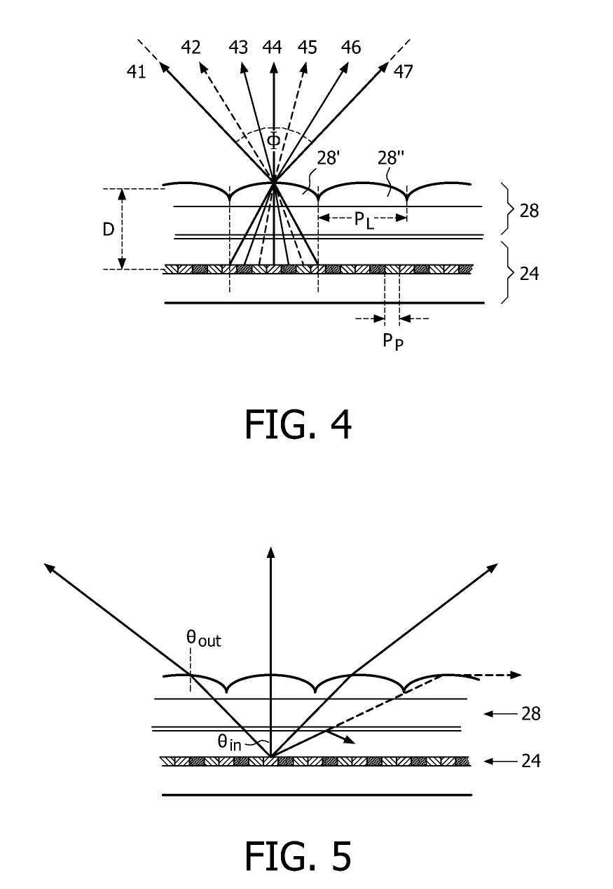

FIG. 4 shows a cross-section of the layout of a multi-view auto-stereoscopic display, e.g. such as the one of FIG. 2. Again the LCD panel 24 bears on top the lenticular array 28. The lenticular array has individual lenticulars 28′, 28″ etc. Each pixel underneath a certain lenticular 28′ 28″ etc will contribute to a specific view of the views 41 to 47. In this case each pixel is a sub-pixel of a color pixel, red, green, blue display panel. The different color sub-pixels are represented by the different shadings. All pixels underneath this lens will together contribute to a cone of views as contained in the angle Φ. The width of this cone as determined by the angle Φ is determined by the combination of several parameters: it depends on the distance D from the pixel plane to the plane of the lenticular lenses. It also depends on the lens pitch P_{L}.

FIG. 5 is a close-up of FIG. 4, and shows that the light emitted by a pixel of the display 24 is collected by the lenticular lens closest to the pixel but also by neighboring lenses of the lenticular arrangement. Thus, information from each pixel is directed into different viewing cones such that overall viewing cones with identical information are repeated in the plane of the drawings. This is the origin of the occurrence of repeated cones of views. Such repetition generally occurs in the lateral direction.

The dependence of the width of a cone (Φ) on these parameters is approximately governed by the relation:

$$Φ = 2 arctan [ \frac{n {P}_{L}}{2 D} ] .$$

In this expression, n is the average index of refraction of the materials in between the pixel plane and the plane of the lenticular lenses (typically, n is in the range from 1.0 (air) to 1.6).

Note that the smaller the angular spacing between two views, the better the 3D effect.

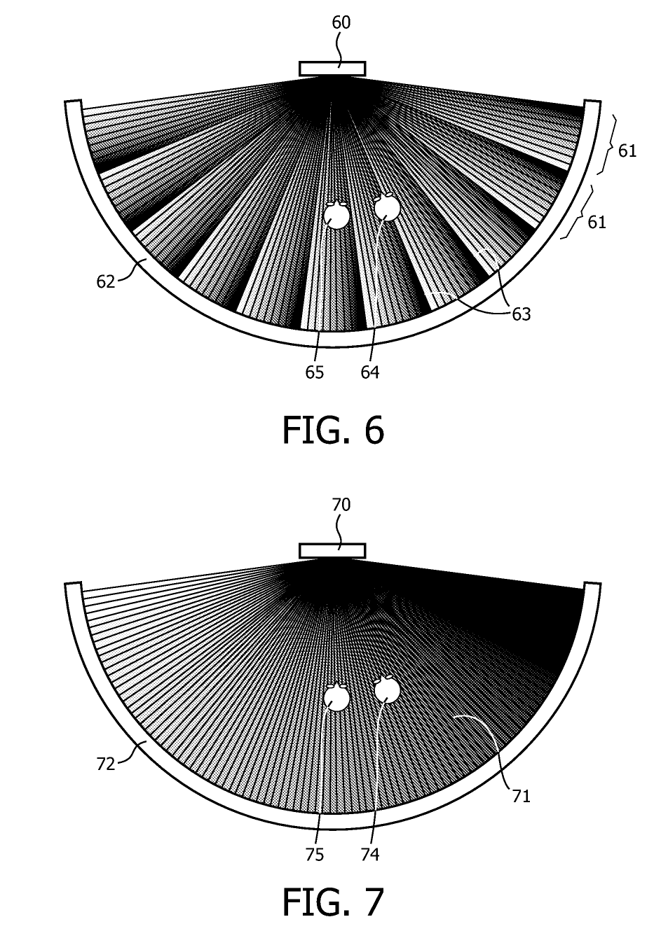

The corresponding views produced in each of the viewing cones are equal. This effect is schematically shown in FIG. 6 for a 9-view autostereoscopic system 60. There system has a field of view 62 with 11 repeating viewing cones 61 with 9 views in each viewing cone 61. The 9 views each have 2D image information of the entire image to be displayed such that different views have a slight difference in parallax for providing stereo perception of the entire image. As explained in the introduction of this application, within one cone there will now be stereo viewing possible with different perspectives towards the content of the image to be displayed such that look around capability is achieved.

For an acceptable compromise between 3D effect and resolution penalty, the total number of views is limited to typically 9 or 15, but other arrangements may be made. These views have an angular width of typically 1°-2°. The views and the cones have the property that they are periodic. If the user walks around the display (e.g. in the lateral direction) he will at some point cross the viewing cone boundaries 63 between adjacent viewing cones. Thus, in a certain region around these boundaries the images in both eyes will not properly match with respect to parallax and/or perspective. This is shown for the viewer 64 in FIG. 6. In the case of e.g. a 9-view system the left eye will receive e.g. the 9^{th} 2D image and the right eye will receive e.g. the 1^{st} 2D image of the total image displayed. First of all, the left and right images are reversed, which means that the image is pseudoscopic. Secondly, and more severe, there is a very large disparity between the images. This is referred to as “super pseudoscopic” viewing. As the viewer moves across the cone boundaries very annoying discontinuous jumps are observed.

Only a viewer located entirely within a certain cone (for example the viewer 65 to the left in FIG. 6) will experience a 3D effect since the views that are directed towards his left and right eye then slightly differ (e.g. views 4 and 5 for the left and right eye are parallactic, respectively).

To summarize, it is the aim of this invention disclosure to provide a solution for the occurrence of cone transitions while retaining a good 3D effect.

A first embodiment according to the invention will be described next with reference to FIG. 7, which shows the ideal solution of the problem of the occurrence of repeated cones and cone transitions. FIG. 7 shows a system 70 having only a single cone 71 consisting of many views (i.e. the angle (Φ) is close to)180°, so that there are no cone transitions. Thus, the viewing cone width is the same as the field of view of the system 70.

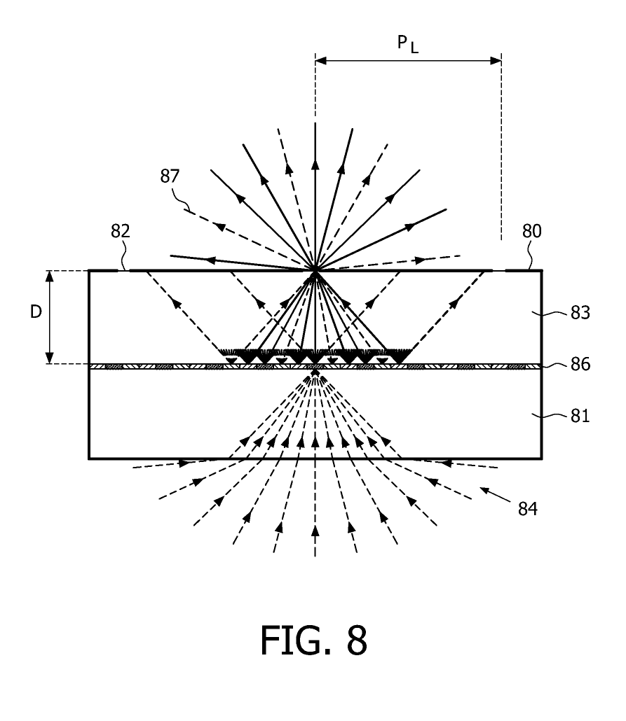

FIG. 8 shows a basic embodiment for such a “single cone” display. It consists of a display having a display panel with a pixel plane 86 equipped with a barrier 80 with relatively narrow transparent apertures (slits) 82. The barrier is spaced from the display panel with a distance D. The light 84 stemming from a backlight lighting arrangement (not shown) enters the glass 81 of the display from the backlight-side. Inside the glass, the angle of the incoming light with the display normal varies between 0° and 42° (assuming that the light from the backlight—in air-varies between 0° and 90° and that the refractive index of the display glass is 1.5). Since the angular spread of the light inside the glass is limited, repeated views can be avoided by making the pitch P of the barrier sufficiently large. As a rule of thumb, the pitch P of the barrier should be typically two times the distance D of the barrier to the pixel plane 86. The exact ratio of pitch and distance depends on the slit width (opening of the apertures) and the refractive index of the glass/medium 83 between the pixels 86 and the barrier 80.

This arrangement requires many views 87 (only one of the views has the reference number in the FIG. 8) to achieve a good 3D effect: This implies that the spatial resolution of each of the views will be very low. The available number of pixels of the pixel panel (LC panel in this case) has to be divided among the views; the more views, the lower the number of pixels available for each view.

This drawback can only be resolved by using a pixel panel (LC panel in this case) having a very high number of pixels (e.g. by using a quad-full-high-definition panel (3840×2160 pixels)). Also light throughput will be limited due to the reduced aperture sizes.

To provide the 180 degree field of view, and to improve light efficiency, also lenses can be used. In particular, this requires broad lenses (large lens pitch P_{L}) as well as very strong lenses in combination with a small distance of pixel plane to plane of the lenticular lenses (D). Such strong lenses cannot be made in practice (their radius of curvature R would be smaller than P_{L}/2, implying that even a hemispherical lens would not be strong enough).

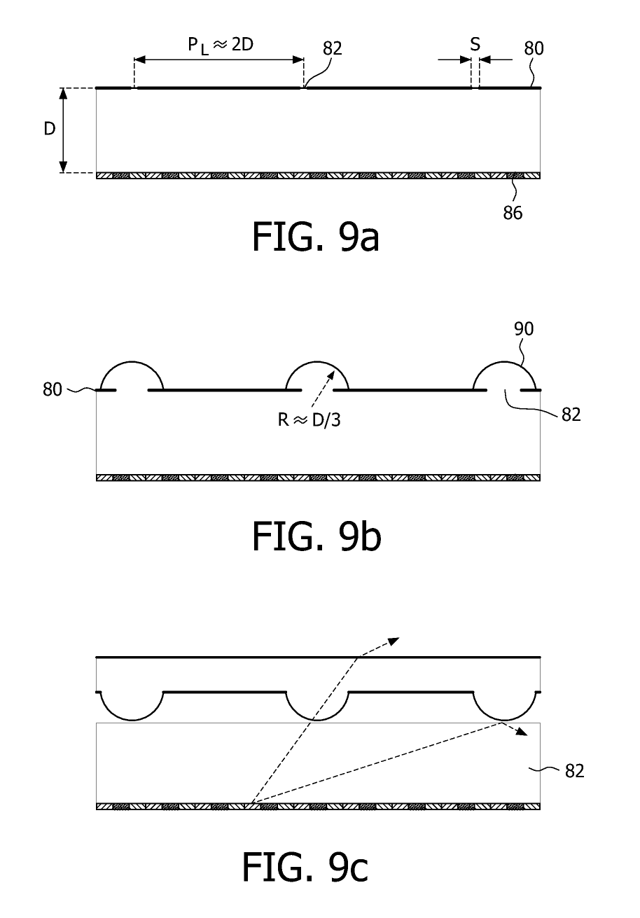

This drawback can be resolved in a manner explained with reference to FIG. 9. This involves widening the apertures 82 in the barrier 80 and placing a lens 90 at (and essentially in the plane of) each aperture to improve the light throughput.

Thus, the invention relates to various arrangements which combine barrier and lens arrangements.

The angular extent of the light rays being present within an LC panel is limited to θₘₐₓ=sin⁻¹(1/n). Here, n is the index of refraction of the substrate and cover glass of the LC panel. Typically n=1.52, resulting in θₘₐₓ=±41°.

This is simply the result of Snell's law: rays originating from the backlight, when entering the glass substrate of the LC panel, will be refracted towards the normal direction.

This implies that with the layout shown in FIG. 9a, showing a simple light blocking barrier with a periodic array of transparent slits in front of an LC panel, a single cone of views will be generated provided the following holds:

P_{L}−S≧2D·tan(θₘₐₓ).

In this relation, S is the width of the slits in the barrier and D is the spacing between the barrier arrangement and the LC panel. In practice, S should be small in order not to broaden the individual views. In that case, combined with tan(θₘₐₓ)≈1, the minimum value for P_{L} is P_{L}≈2D; therefore, preferably, P_{L}>2 D.

A small value for the width of the slits S implies a low transmission: most of the light is lost. A solution is to increase the width of the slits and combine the slits with a lenticular lens, as shown in FIG. 9b and FIG. 9c. The lenticular lens should have a focal length ƒ substantially similar to the distance from lens to pixel plane. This ensures that the overlap between neighboring views remains small.

By approximation, the focal length of a lenticular lens obeys the relation ƒ≈R n/(n−1), where R is the radius of curvature of the lens. Assuming n=1.52 and ƒ=D, it follows that R≈D/3. Preferably, 0.2 D<R<0.5 D.

The optical quality of the lenticular lenses can be improved by choosing the slits in the barrier to be narrower than the width of the lenses (as shown in FIG. 9b).

If an OLED display panel (or any other emitting pixel panel nor requiring backlighting and spatial light modulation) is used instead of an LC panel, the rays emitted by an OLED pixel are not confined to a limited angular range; instead they span the full range from −90° to +90° inside the glass cover of the OLED. As a result, rays emitted at large angles can easily reach neighboring and next-neighboring slits. However, these spurious rays will not pose a problem provided that a mechanism of total-internal-reflection is used to make sure these rays cannot leave the cover glass 91 of the OLED panel. An example of such internal total reflection solution is shown schematically in FIG. 9c, where out coupling of light into the lenses is now bound by angle of incidence of the light by ensuring that the lens curvature faces the cover glass of the emitting pixel panel (OLED panel). Thus, for both types of display, the angle of light paths between the display panel and the barrier arrangement is limited to a first range each side of a normal direction. This enables the barrier to function to ensure the light from one pixel only reaches one barrier opening.

The combination of the lens and barrier means that the angle of light paths to the field of view of the display device is in a second range at each side of a normal direction, with the second range greater than the first range. At the limit, the second range is 90 degrees, so that the display output field of view and thus viewing cone is the full 180 degrees.

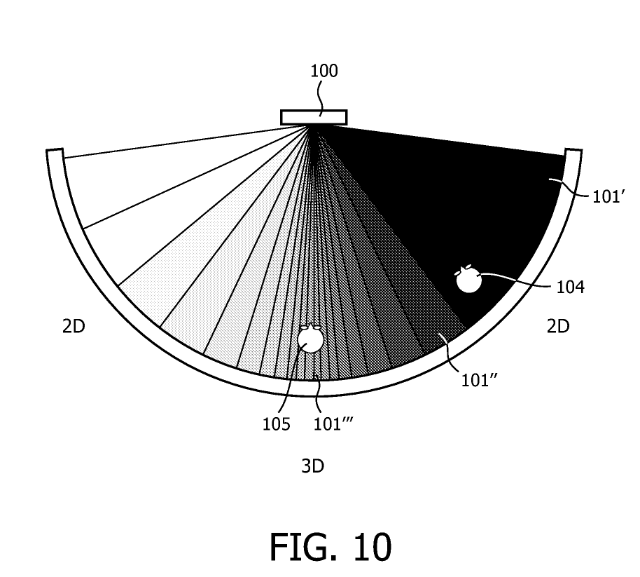

An autostereoscopic device 100 according to a second embodiment according to the invention is described with reference to FIG. 10. Again, there is only a single viewing cone spanning the field of view 102. In this case, the density of views is high at small viewing angles and low at large viewing angles. This results in a good 3D image quality at relatively small viewing angles (in the lateral direction) for e.g. viewer 105 and a good 2D image quality at larger viewing angles for e.g. viewer 104.

Thus, the views 101 including e.g. views 101′, 101″ and 101′″ are distributed in a non-linear manner. That is to say, the views are arranged such that the view spacing is small for views leaving the display almost perpendicularly (i.e. small viewing angles such as e.g. view 101′″). For increasing viewing angle, the view spacing is increased (such as for e.g. views 101″ and 101′). Not all views thus have the same view width.

As mentioned above, the smaller the angular spacing between neighboring views the more pronounced the 3D effect, and vice versa. This implies that a viewer watching the display at small viewing angles will see a high-quality 3D image (e.g. viewer 105) whereas at increasing viewing angles the 3D effect will gradually decline and eventually reduce to a 2D image (e.g. viewer 104).

The advantage is that in this manner only a limited number of views is needed, implying a good spatial resolution can be obtained within each view. At the same time no view repetition occurs.

A small overlap can be provided between neighboring views for small viewing angles (this helps to achieve a good 3D effect) and a gradually increasing overlap for increasing viewing angles. Especially at large viewing angles where the 3D effect will be reduced, a good quality 2D effect can be obtained by providing a large overlap between views. By rendering the outer views with the same image content and allowing for a large overlap between these views, the apparent spatial resolution of the image as seen by a viewer is increased. In other words, for small viewing angles the views are rendered as 3D views and for large viewing angles the views are rendered as 2D views.

View rendering is the process of assigning the proper image information to the required pixels such that the information ends up on the required views. The person skilled in the art will be able to address the pixel plane using conventional electronics and display equipment such that he achieves such rendering.

The way in which views can be redistributed in a non-linear manner will now be explained.

With reference to FIG. 5, let θᵢₙ be the angle at which a light ray is emitted by a certain pixel and θₒᵤₜ be the angle at which this light ray leaves the 3D display. The relation between θᵢₙ and θₒᵤₜ obeys Snell's law:

n sin(θᵢₙ)=sin(θₒᵤₜ).

Note that in this relation, n is the index of refraction of the cover glass of the LC panel. From this relation we can determine the change in θ ₒᵤₜ upon slightly changing θᵢₙ:

$$\frac{d {θ}_{out}}{d {θ}_{in}} = \frac{1}{n} \frac{cos ( {θ}_{in} )}{\sqrt{1 - {n}^{2} {sin}^{2} ( {θ}_{in} )}} .$$

Defining the function ƒ(θᵢₙ):

$$f ( {θ}_{in} ) = n \frac{d {θ}_{out}}{d {θ}_{in}} .$$

It can been shown that the result is:

$${f}_{prior art} ( {θ}_{in} ) = \frac{cos ( {θ}_{in} )}{\sqrt{1 - {n}^{2} {sin}^{2} ( {θ}_{in} )}}$$

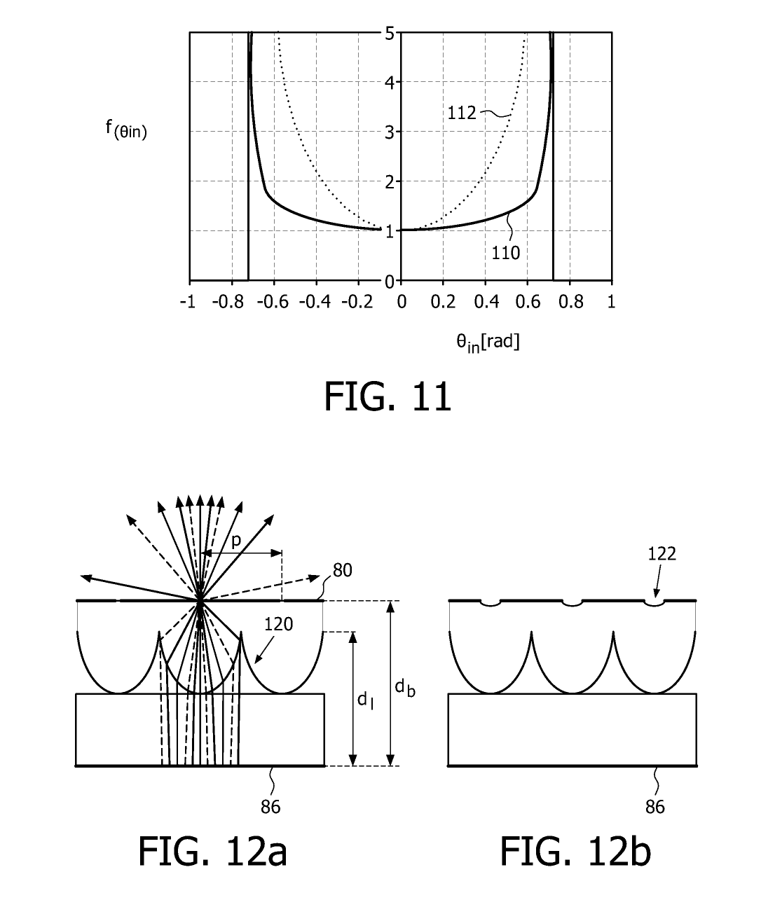

This function is proportional to dθₒᵤₜ/dθᵢₙ (and therefore proportional to the angular distance between neighboring views) and is normalized to unity for θᵢₙ=0 (corresponding to viewing angle zero). For n=1.52, this relation is graphically depicted in FIG. 11. The solid line 110 represents the behavior obeyed by the prior art. The dotted line 112 represents an example according to the invention.

Thus, view distributions are preferred which are characterized by the function f(θᵢₙ), that obey the relation f(θᵢₙ)>1.05 f_{prior art}(θᵢₙ) for all values of θᵢₙ. This corresponds to view distributions occupying the shaded area in FIG. 11. The shaded area in the figure corresponds to f(θᵢₙ)>f_{prior art}(θᵢₙ).

A drawback of the examples above having a lens in the aperture is that the view spacing cannot easily be tuned. The spacing is mainly dictated by the refraction at the glass-air interface of apertures or lenses. The resulting view spacing increases as the (central) angle of the views with the display normal increases, but a steeper increase may be desired.

Thus, a refinement to the examples above is again based on a combination of at least one layer with light blocking elements (barriers) and at least one layer with lenticulars (lenses). However, these layers are at different specific distances from the underlying display. This measure enables the view spacing to be tailored according to requirements.

It is clear from the examples above that the function of the barrier is to make a certain selection out of all the rays that pass through the system. By placing the lens and the barrier at different distances from the pixel-plane, light-trajectories corresponding to different exit angles will intersect the lens surface at different positions. The slope and curvature of the lens at these positions can be adjusted depending on (or as a function of) the exit angle. This way, the spacing between the views (the width of the views) can be varied.

A first embodiment is shown in FIG. 12a. Following the light from the display pixels in the pixel plane 86 towards the viewer, the rays first encounter the lens 120 and then encounter the barrier. The apertures in the barrier can initially be assumed to be narrow “pinhole” slits. The design requirements can be easiest understood by tracing back the rays from outside, through the barrier aperture. In that case, the rays in the medium between barrier and lens occupy angles between 0° and 42° (assuming n=1.5) with respect to the display normal. All rays “emerging” from the aperture should be “captured” by the lens. Setting d=d_{b}-dₗ, d being the distance between the part-of-the lens-closest-to-the-barrier and the barrier. Now, as with the geometry shown in FIG. 5, d should approximately satisfy: d/p≈0.5.

The detailed shape of the lens depends on the requirements with respect to view spacing. For practical purposes, a circular or elliptical cross-section could give acceptable view distributions. Generally, the lens may—but need not-be very aspheric. The radius of curvature in the centre of the lens (lens 120) is determined by the required view spacing of the views around the display normal.

A drawback of using a very narrow aperture in the barrier is that the average transmission of the barrier and hence the brightness of the display becomes low. If the size of the aperture is increased without further measures, the brightness will increase, but also angular overlap (cross-talk) between the views will increase. To avoid this, an additional lens (lens 122) can be placed in or very close to the aperture. This is shown in FIG. 12b. In the case shown, lens 122 is negative.

The role/design flow of lenses 120 and 122 is such that lens 120 is designed to give the proper view distribution in cooperation with a pinhole type barrier. Then lens 122 is designed such that a pencil of rays emerging within a narrow angular range from the centre of the display pixel generating the central view, after passing the centre of lens 120 and after passing lens 122, is emitted as a parallel beam towards the viewer. The width of the aperture is chosen as large as possible, but such that the cross talk between the views is not too much compromised. Following this design flow, a good compromise between 1) view-spacing, 2) cross talk between the views, and 3) brightness is obtained.

In the design of FIG. 12, the ratio of the distance (dₗ) of the lenses 120 from the display panel 86 to the distance d_{b} of the barrier arrangement 80 from the display panel 86 is in the range 0.3 to 0.6.

One possible issue for both embodiments shown in FIG. 12 is that the shape of the lens is not very practical in terms of manufacturability. The lens tends to become very “deep”, and at the points where two neighboring lenses intersect, the lens curves are almost tangential to the display normal.

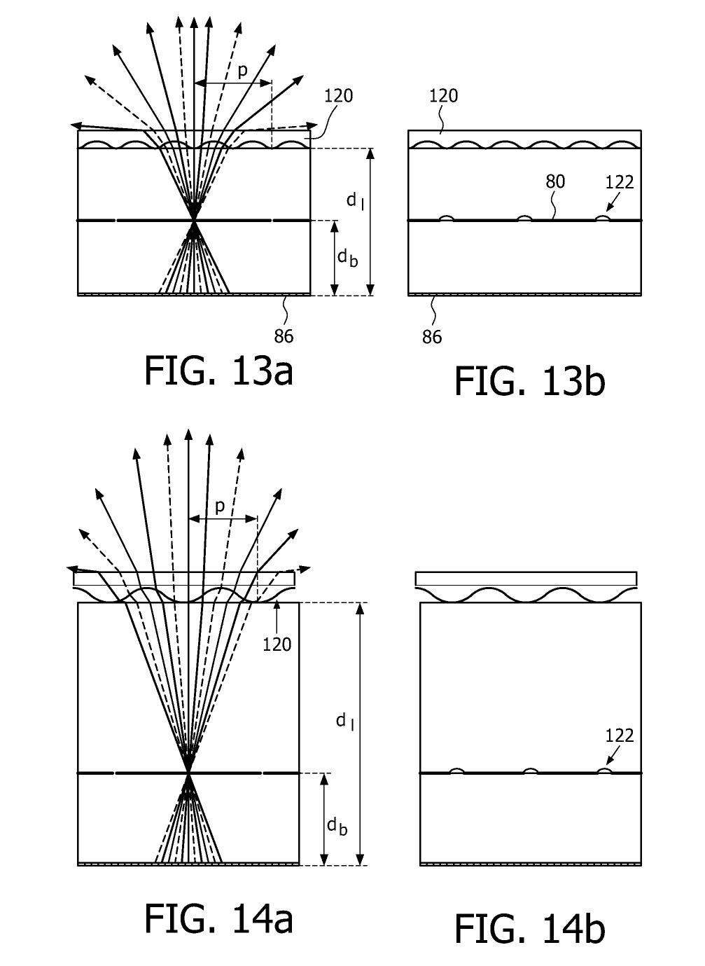

A more preferred embodiment is shown in FIG. 13a. Following the light from the display pixels towards the viewer, the rays first encounter the barrier and then encounter the lens. The barrier is chosen such that no repeating views can occur (see FIG. 5), hence: d_{b}/p≈0.5. It turns out that for acceptable view distributions a wave-like lens is preferred. The advantage of this geometry is that it is less deep and does not contain “difficult” slopes. Note that within one lens pitch, the lens curve touches the glass between barrier and lens twice. The lens is highly aspheric. All rays emerging from the barrier aperture should be “captured” by the lens. This means that, if we set d=dₗ-d_{b}, d should approximately satisfy: d/p≈0.5.

In this case, the ratio of the distance dₗ of the lenses 120 from the display panel 86 to the distance d_{b} of the barrier arrangement 80 from the display panel 86 is preferably in the range 1.5 to 2.5.

As with the previous embodiment, the apertures in the barriers can be increased and equipped with lenses 122. This is shown in FIG. 13b.

For practical designs it is advantageous to place the barrier as close as possible to the display pixels. Typically, this minimum distance is about 1 mm. This means that the barrier-lens distance is also about 1 mm and the barrier/lens pitch is approximately 2 mm. The total number of views can be 20-40, depending on the display under consideration. The spacing of the views close to the surface normal is determined by the curvature of the lens surface in the centre. Typically, the desired view spacing close to the surface normal is 1°-2°. In many practical situations this means that the curvature at the centre must be chosen such that the corresponding focal plane is very close to the barrier (slightly “below” the barrier). To achieve this, the curvature must be strong. Now, a problem arises if we want to widen the aperture and place a lens (lens 122) in it to keep the views more or less collimated. Because the main lens (lens 120) is strongly curved, lens 122 must be a strongly curved negative lens. It turns out in practice that this limits the size of the apertures and/or the performance of the system. Therefore, lens 120 is preferably placed further away from the barrier, such that the curvature in the centre can be reduced accordingly.

A third embodiment with increased barrier lens distance is shown in FIG. 14a. The main lens is cosine-shaped. When compared to the previous embodiment, the barrier-lens distance has doubled. The lens pitch has remained the same, but the lens touches the underlying glass only once per pitch. The rays coming through a barrier aperture are “captured” by actually two (or, alternatively, half+one+half) lenses. A part of the lens that acts as “central part” for one barrier aperture acts as “edge part” for the neighboring aperture. Each part of the lens is used two times, i.e. irradiated from two apertures. The advantage is that the lens can be less curved in the centre. As a result the barrier aperture can be increased and a less negative lens is needed to collimate the central views. In this case, the ratio of the distance dₗ of the lenses 120 from the display panel 86 to the distance d_{b} of the barrier arrangement 80 from the display panel 86 is preferably in the range 2.5 to 3.5.

In FIGS. 13 and 14, the ratio of the distance d_{b} of the barrier arrangement 80 from the display panel 86 to the pitch p of the openings 82 of the barrier arrangement 80 is in the range 0.3 to 0.6.

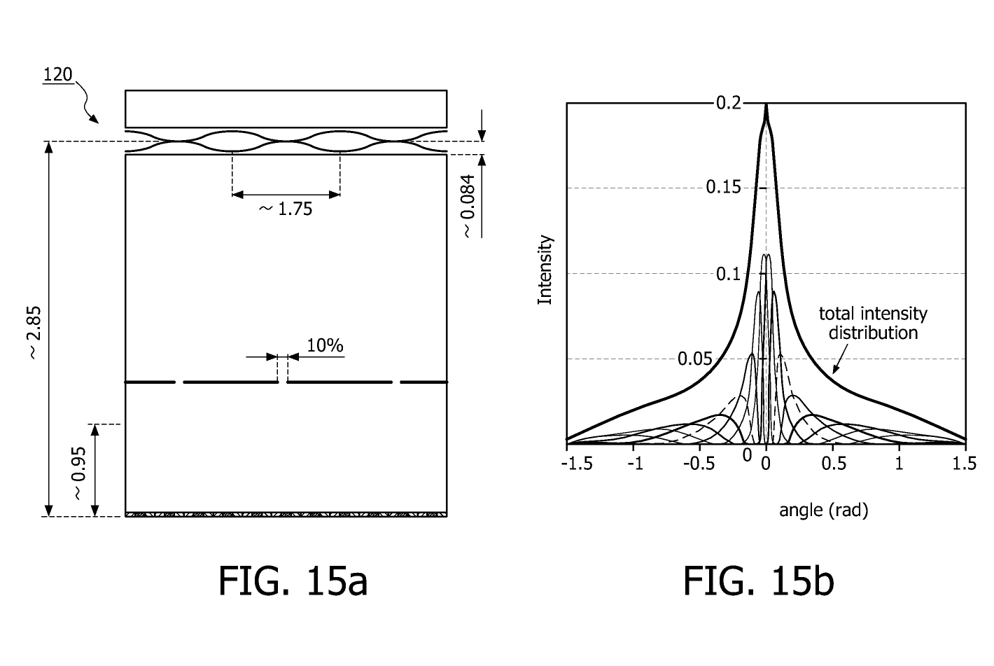

FIG. 15 shows an actual design for a 42″ (107 cm) display (1920×1080 pixels). The main lens 120 consists of a combination of two stacked cosine lenses. The reason is that this is easier to manufacture than one lens with “double depth”. For simplicity, a reasonably wide aperture (10% transmission) is chosen and lens 122 is not used. This can be done if the curvatures in the centre of the lens (or lens stack) are chosen such that the focal plane coincides with the pixel plane. This ensures that the views are collimated. Presuming that the lens is cosine-shaped and knowing the curvature, the design is fixed.

The lenses of course do not need precise sinusoidal shapes. Generally, they will have a periodic shape between alternating maxima and minima, with the distance between an adjacent minima and maxima corresponding to half the lens pitch.

The graph in FIG. 15 shows the resulting view distribution. The total number of views is 22. The views around the display normal are relatively closely spaced. For larger off-normal angles the views become more widely spaced. A display according to this design will be able to display 3D content to a viewer positioned around the display normal, and 2D content to a viewer looking to the display at more oblique angles. As expected, the barrier takes away light. The average transmission is 10%. The amount of light peaks around the display normal. The maximum transmission is 25%. In the 3D zone the brightness is reduced to 25% of the original (i.e. with no lenses/barriers), whereas for larger angles the brightness is reduced to less than 10%. These numbers depend of course on several design choices and may be improved.

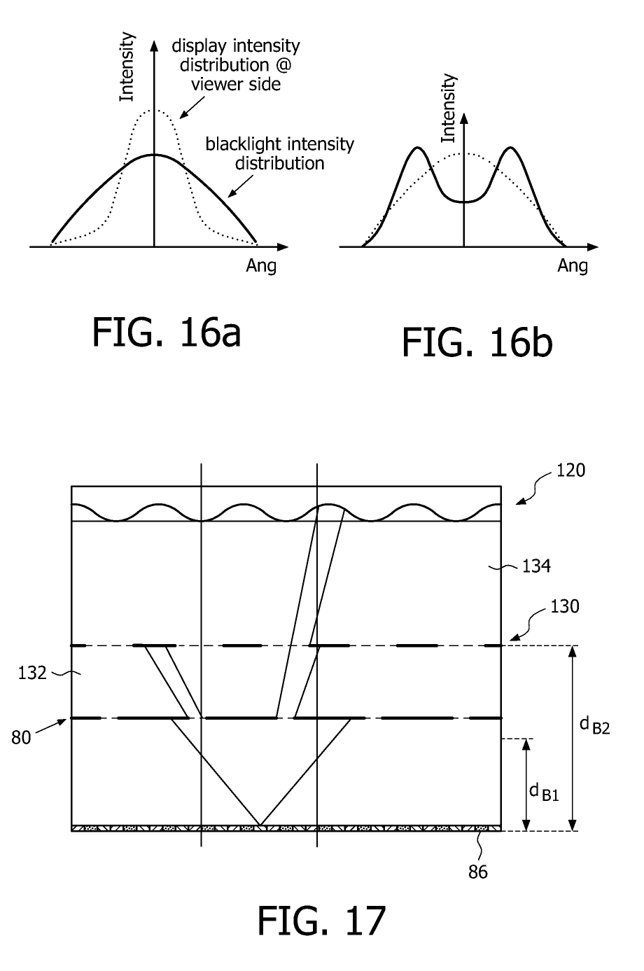

The total intensity distribution is typical for the embodiments above. As a result the 3D display will look rather dim when viewed at large viewing angles. In the calculations it has been assumed that the angular distribution of the light from the backlight is Lambertian. To improve the angular dependence of the intensity distribution, the backlight can be adapted to increase its luminance at large angles at the expense of the luminance at small angles. This is schematically shown in FIG. 16. A practical way to achieve this is to turn the brightness-enhancement-foils (BEF as produced by Vikuity (a 3M company)) upside down (i.e. with the patterned surface away from the panel and oriented towards the backlight).

The examples above combine a single lens arrangement with a single barrier arrangement. A modification is described below which uses two barrier arrangements. It is likely that pixel sizes will continue to reduce and display resolutions will increase in the near future. When implementing the single barrier approach above for a single cone display, this means that the LC panel cover glass thickness needs to be downscaled accordingly in the design, so that light from a pixel only reaches a single barrier opening. The use of a second barrier in the single cone display design avoids the need to scale down the glass panel thickness when the pixel resolution is increased.

An increase in resolution enables a trade off between an increased number of views on the one hand, or an increased resolution on the other hand. This selection can be implemented with an appropriate choice of the pitch of the slits in the barrier. In the examples above, the minimum pitch is defined by the LC panel cover glass thickness. It will be shown below that the use of a second barrier enables this restriction to be avoided.

FIG. 17 shows an example of a double-barrier design, comprising the LC panel 86, the first barrier arrangement 80 and the (main) lens arrangement 120. A second barrier arrangement 130 is provided between the output of the first barrier arrangement 80 and the lens arrangement 120. The spacing between the LC panel 86 and the first barrier arrangement 80 is d_{B1}, and this has a minimum dictated by the thickness of the LC panel cover glass. The spacing between the LC panel 86 and the second barrier arrangement 130 is d_{B2}.

Pixel sizes are expected to reduce but the minimum LC panel cover glass thickness will not reduce at the same pace. This means it will not be possible to reduce significantly the value of D (which in the analysis above gives the minimum barrier pitch P_{L}≈2D). This means that although more pixels are available, the apparent resolution of the 3D views cannot be increased significantly since the perceived resolution is determined by the barrier pitch P_{L} which cannot be reduced significantly since the thickness D cannot be reduced further. The second barrier 130 shown in FIG. 17 resolves this issue.

The pitches of both barriers are substantially equal. This arrangement enables the barrier pitch to be reduced below the previous limit of 2D (i.e. 2_{B1}). Thus P_{B1}=P_{B2}<2d_{B1}.

This means that rays emitted by a certain pixel can travel through more than one slit in the first barrier, resulting in repeated cones. To prevent repeated cones reaching the viewer, the spurious rays are blocked by the second barrier. This is shown in FIG. 17.

The slits in the second barrier 130 are wider than the slits in the first barrier: S_{B1}<S_{B2}.

Typically, d_{B1} is set equal to the thickness of the LC panel cover glass. Also, typically, 1.2<d_{B2}/d_{B1}<2.0. Similarly, typically, 1.2<S_{B2}/S_{B1}<5.0.

In the same way as for the examples above, the width of the slits in the first barrier is determined by the actual pixel size, the thickness of the LC panel front cover glass, and the index of refraction of the cover glass. The period of the slits is defined by the chosen number of 3D views in combination with the lenticular slant angle.

The combination of the two barriers means that light from a pixel is again not coupled into more than one view, so that viewing cone repetition is avoided. Thus, the second barrier gives greater design freedom to trade off the number of views against resolution per view when higher display resolutions become available.

Both barrier arrangements can be on separate thin film foils, or be integrated on either side of a substrate layer 132. The necessary width of the slits in the second barrier depends on the choice of the width of the slits in the first barrier as well as on the distance from first to second barrier layer. From a design perspective it is beneficial (for smaller light ray angles) to have an intermediate medium with index of refraction n between both barrier layers. Both barrier layers may be in optical contact with this substrate.

A second substrate 134 is provided on top of the barrier stack. The front surface of this substrate is provided with the lenticular-like lens array which can have the same designs as outlined above, for example a cosine shaped cross-section. As in the examples above, this lens array images the pixel plane of the display towards infinity. The cross-sectional shape of the lens array determines the angular spread of the different views. The substrate of the lens array may or may not be in optical contact with the second barrier layer.

The slits in one or both barriers can be provided with additional lenses in the same way as explained for the examples above, to enable an increase in the slit size while still having an acceptable 3D quality. An increased slit size will result in less light being blocked by the barriers, thereby resulting in a more cost efficient system.

The different substrate layers (containing the optical features) in the designs above can be of substantial thickness, resulting in increased weight of the 3D display. Therefore an additional modification to the designs above involves eliminating the material in the optical non-active zones of the different substrate layers.

This approach will be explained for the types of design shown in FIGS. 8 and 17.

The operation of single blocking barrier single-cone 3D display of FIG. 8 relies on the principle of selecting a particular group of pixels of the LCD by using a substrate which acts as a waveguide for light rays beyond the critical angle of total internal reflection.

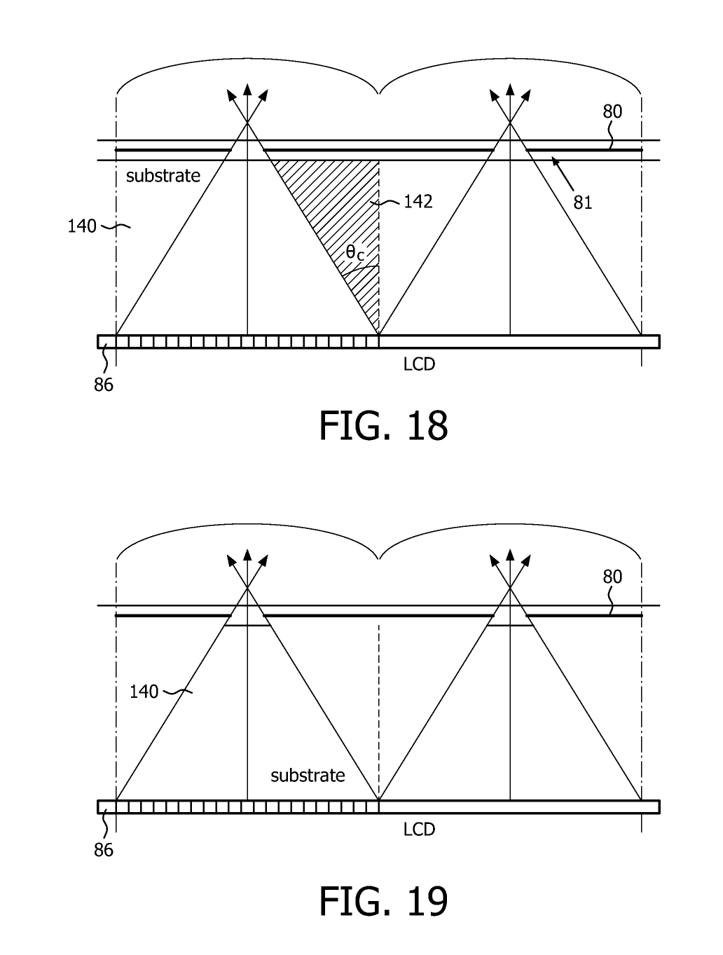

FIG. 18 shows schematically the relevant angles. An airgap 81 is present between the blocking barrier 80 and the substrate 140, and as a result there is a critical angle defined by the inverse sine of the ratio of the air refractive index and the refractive index of the substrate, respectively.

This airgap 81 is needed if the backlight arrangement does not already provide limitation of the angular spread. For example, in FIG. 8, the air-glass interface between the backlight and the LCD panel provides angular limitation. If the backlight is in direct contact with the LCD panel, for example an OLED backlight, then the airgap 81 can be used to provide the desired angle limitation.

The substrate thickness H cannot be chosen arbitrarily in this case. Its maximum thickness (H) depends on the size (P) of the pixels in the LCD, the number (N) of views (i.e. the number of pixels underneath a particular lenticular), and the index of refraction of the substrate material, and the slit size (S). The substrate thickness is expressed by:

$$H = \frac{( N \cdot P - S )}{2 \cdot tan {θ}_{c}} .$$

The hatched area 142 in FIG. 18 (and other corresponding areas—the hatch area shown is for one half of the period of the barrier slits) represents the substrate material which can be removed without affecting the optical functionality. Theoretically 45% weight reduction can be obtained if the slit opening S is not greater than 10% of the lenticular pitch. The substrate slab 140 with removed material is illustrated in FIG. 19. The barrier 80 can be applied at the bottom surface of the lenticular array.

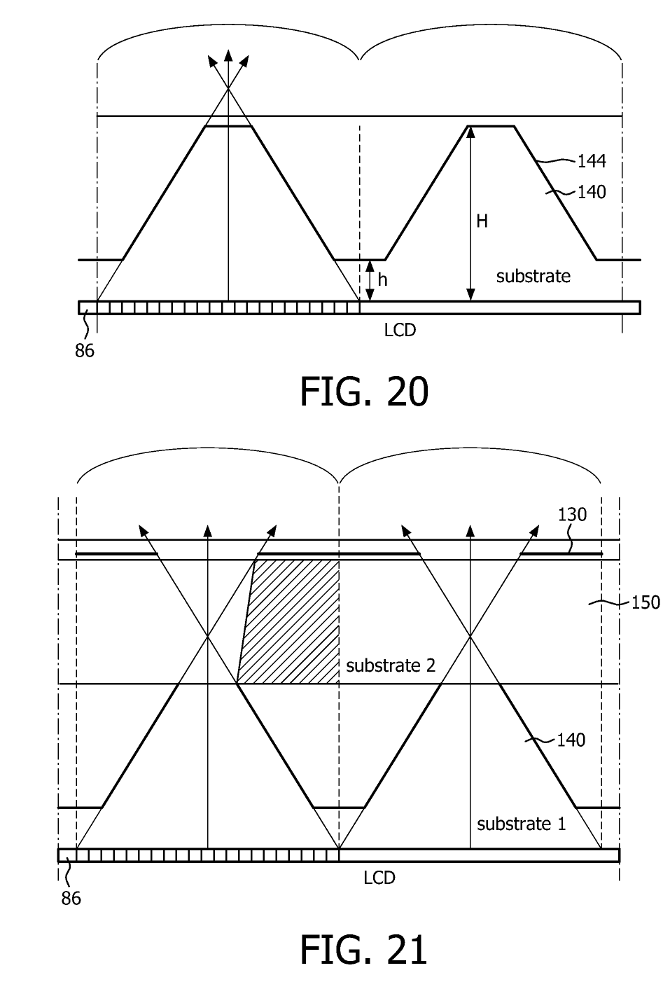

In practice, as shown in FIG. 20, a minimum height h is necessary to maintain one single substrate plate with sufficient mechanical rigidity. In that case the maximum volume (weight) reduction is:

$$[ 1 - {( \frac{h}{\sqrt{2} \cdot H} )}^{2} ] \cdot 50 \%$$

Instead of using a planar barrier 80, FIG. 20 also shows the sidewalls 144 made optically absorptive. By coating the reshaped substrate with an optical absorber, unwanted

Fresnel backreflections into the substrate slab can be blocked, in additional to providing the desired barrier opening function.

The maximum substrate thickness defined above as

$$H = \frac{( N \cdot P - S )}{2 \cdot tan {θ}_{c}}$$

may not be feasible to achieve, when the display resolution increases (i.e. pixel size P scales down). It is then necessary to incorporate a second blocking barrier into the optical system to limit the field of view (through the first slit) to the right set of pixels, thus providing the dual barrier single-cone 3D display example of FIG. 17.

FIG. 21 shows an arrangement corresponding to FIG. 17, but in which the lower barrier is already replaced with a reduced weight coated substrate as shown in FIG. 20. The first and second substrates are in optical contact.

It can be shown with geometrical calculations that the thickness of the second substrate plate 150 should be minimally

$$\frac{N}{( N + 1 )} \cdot H ,$$

with H being the thickness of the first blocking barrier substrate 140 and N being the number of views in the single cone (i.e. also the number of pixels underneath a single lenticular). The second barrier 130 has a blocking absorbing zone with a width of 2b, with

$$b = \frac{N}{( N + 1 )} \cdot \frac{P}{2} \cdot ( N - β - 2 N β )$$

The parameter P is the size of a single pixel in the LCD. Parameter β is the scale factor for the opening of the first transmissive slit. In practice β is maximally 10% of the lenticular pitch (=0,10. N.P) to keep view broadening small.

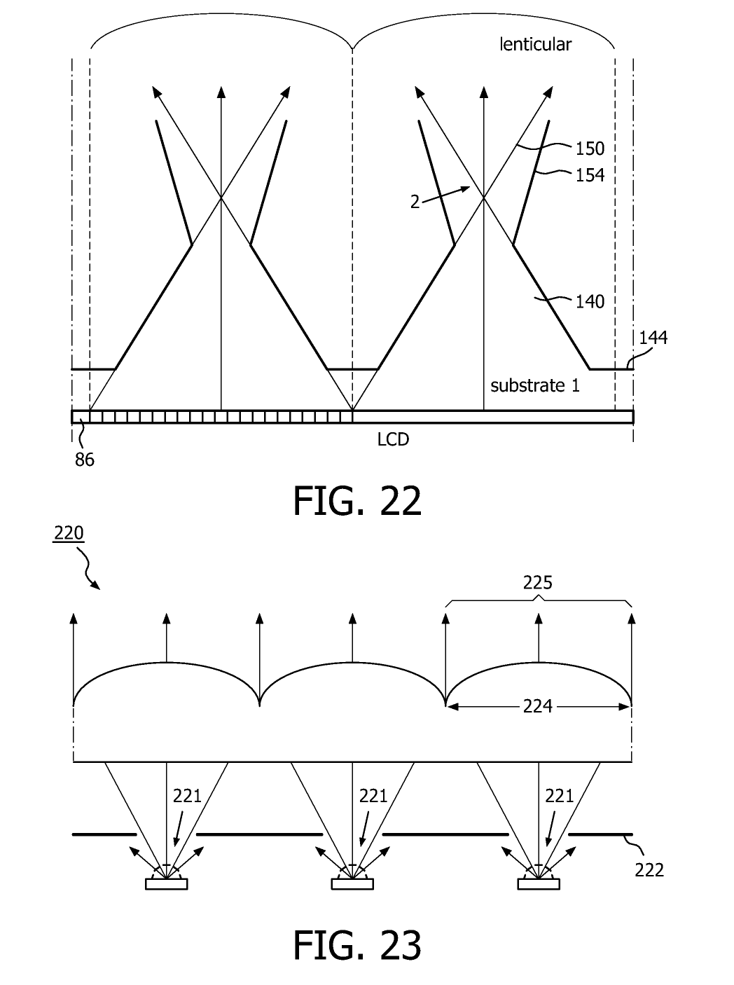

In FIG. 21, the region of the material which can be safely removed in the second substrate layer is again hatched as region 152. The other corresponding regions can also be removed. Since light rays travel in straight trajectories in a homogeneous material, they cannot be present beyond the line that connects the edges of the first and second transmitting slits. The resulting reshaped second substrate is illustrated in FIG. 22. By using the parameter b and H, it can be shown that a volume reduction of

$$\frac{( 2 N - 2 β - 3 β N + 1 )}{( N + 1 )} \cdot 50 \%$$

is possible. For example, if the slit of the first barrier has an opening of 10% (β=0.1) and the screen has 9 views (N=9), a volume reduction of 80% is possible in the second substrate plate.

FIG. 22 also shows that the barrier layer 130 can be replaced with an absorbing coating 154.

Thus, it can be seen that for both designs, the barrier arrangement comprises at least one transparent slab, wherein the slab is shaped with a cross section in the shape of a rectangle with cut-outs, wherein the cut-outs are positioned in areas outside the regions to which the light paths between the display panel and the barrier arrangement are limited. This approach is possible for the single slab when a single barrier is used or for both slabs when two barrier arrangements are used.

Since the display of the invention uses a barrier with relatively narrow slits in order to select a portion of the light rays coming from pixels to be transmitted into the views generated, the average transmission of the barrier is relatively low, so that the brightness of a display may become low. This may e.g. the case when the display panel is a LCD having a regular uniform illuminating backlight illuminating its light over a broad distribution of angles. It can be seen in the previously described examples such as e.g. those of FIGS. 12 and 13, that only part of the light of the backlight will pass the apertures to provide the display for the viewer.

In order to improve the brightness of the display of the invention, the display may comprise a light source, e.g. a collimating backlight that provides collimated light, where the collimation is such that the collimated light beams at least partly match those that are selected by the optical construction of the view generating optics (barrier and lens arrangement). Preferably the collimation is such that beams match entirely so that no light is lost at all. The collimation of light ensures that more light of the backlight ends up in the views to be observed, therewith enhancing the brightness of a display having the regular uniformly lighting backlight.

Next, examples of displays with collimating backlights will be described. Preferably the collimated backlight is configured such that it provides collimated light consisting of one or more parallel beams emitted in one single direction. Preferably this direction is perpendicular to the illumination direction of the backlight.

FIG. 23 is an example of a collimating backlight 220 that can be used in the display of the invention. The collimating backlight comprises an array of light sources, such as light emitting diodes (LEDs) 221, a backlight barrier 222 having backlight apertures 223 for passing the light source light and backlight lenses 224 for collimating the light that passed the apertures. Preferably every light source is optically associated with one aperture and one lens such that the light of one light source passes only one aperture and the light that passes the aperture is collected by only one lens. The light sources may be spaced apart with dark regions in between to help the optical association.

In the embodiment of FIG. 23, the light source is located in the focal point or plane of the lens it is associated with. In this way the light passing the aperture is collimated by the lens to from a parallel beam of light 225 having a parallel beam width 226. The direction 227 of the parallel beam may be set or steered according to general geometrical optical principles, i.e. by changing e.g. the backlight lens locations with respect to the source etc. In this embodiment the direction of parallel beams is perpendicular to the collimating backlight illumination area. The apertures in the backlight barrier may be relatively wide such as to at least prevent spurious light rays from one source entering a neighboring backlight lens, i.e. e.g. one that is not optically associated with the source the light stems from. Preferably, as in the FIG. 23, the backlight lenses in the lens array have a width and a location such that that their edges coincide and the backlight apertures width and location are such that the light of the light source fills the whole of the lens it is optically associated with, i.e. the light emitted by each light source is limited in angular extent to hit the full lens width. Note that the cross sectional shape of the apertures and/or lenses may be such that the cross sectional shapes of the light beams leaving the backlight fill the plane of the illumination area of the collimating backlight. In this way the backlight provides substantially uniform illumination with parallel beams of light over its entire illuminating area. As said, these beams are perpendicular in this case.

Thus, a collimating backlight may provide light that is confined within one or more beams each of which has a limited angular extent, distinguishing the collimating backlight form the regular uniform backlight. Preferred shapes of the collimated light beams in terms of extent of collimation (extent of angular confinement of the beam) and cross sectional shape are determined by the detailed construction of a display according to the invention. Examples are given below.

An autostereoscopic display that selects parallel beams to end up within its views advantageously may be fitted with a collimating backlight providing such parallel beams. In one embodiment such a display may be that described with reference to FIG. 12. Preferably, the collimating backlight is configured such that its parallel beams have a cross sectional area that matches that of the lenses 120 of the lens arrangement. In that case no light is lost. Thus, as the display of FIG. 12 has semi-cylindrical lenses 120 in the arrangement that select light beams with substantially rectangular cross sectional shape, the backlight is preferably configured such that its light beams match this rectangular shape. Even more preferably, the area of the rectangular shape of the beams of the collimated backlight is at least as small as that of the selected beam as then all light provided by the backlight is selected in the display to end up in the views. The shape of the light beams of the collimating backlight may be chosen using the shape of the backlight apertures in combination with the shape of the backlight lenses. Thus in FIG. 12, the backlight apertures preferably are rectangular slits and the backlight lenses are semi-cyllindrical lenses.

It will be clear that other configurations regarding the shape may be used as dictated by the view generating optics of the autostereoscopic display. For example collimated backlight light beams may have square or hexagonal cross sectional area obtained by apertures and/or lenses of corresponding cross sectional shape.

Alternative to the display with the parallel beam selection, an autostereoscopic display that selects converging beams to end up within its views advantageously can be constructed as described hereinbefore with regard to e.g. FIGS. 8, 13 or 14. Such autostereoscopic displays may be fitted with a collimating backlight providing such converging beams.

Thus, the collimating backlight suitable for this purpose would be one in which the backlight lenses 224 of the collimating backlight 220 would be placed at a distance from the light sources greater than the focal distance, so that converging beams would result.

Note however that as a result, at some distance from the backlight (lenses) where the beam is still converging, there will be regions in between neighboring beams where there is no light. Hence pixels of a regular pixel plane in these regions would not be lit. Either the pixel structure of the display panel is adjusted to omit pixels that are not lit or such pixels are simply not used.

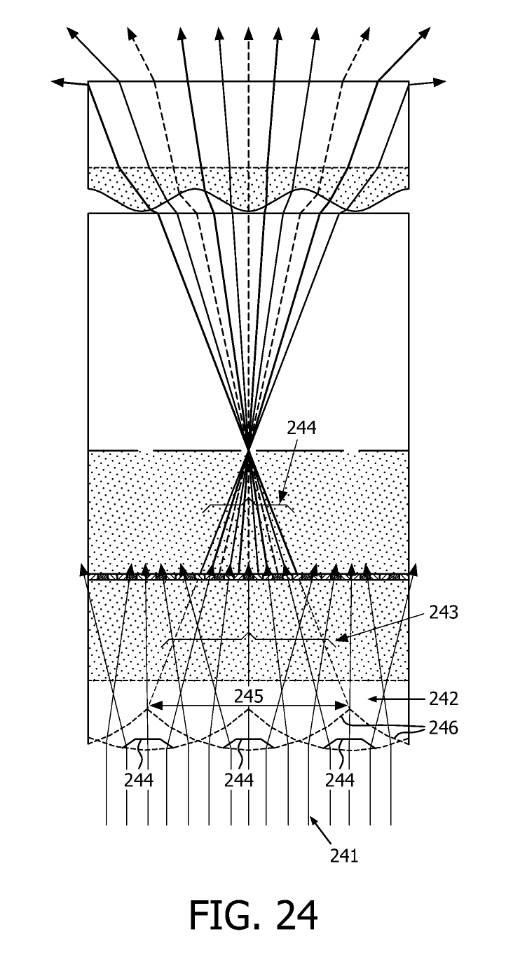

In a preferred embodiment, however, the collimated backlight is then constructed such that no such ‘dark’ non lit regions exist at some point in its convergent beams, so that a maximum number of pixels may be used. This can be done using an optical arrangement with weaved lenses, wherein neighboring lenses overlap through piecewise alteration between the lens segments of the neighboring lenses. The display 240 of FIG. 24 shows an example.

The collimating backlight of FIG. 23 providing parallel perpendicularly oriented light beams 241 in FIG. 24 is used (the backlight is not shown). In addition to the autostereoscopic display embodiment as described with reference to FIG. 13 or 14, an array of weaved lenses 242 is provided to transform the parallel light beams 241 into converging beams 243 that in terms of extent of convergence match the beams 244 selected by the barrier with slits 244. In order to provide one selected beam 244 with full illumination, the lenses of the array of weaved lenses 242 would have to have a width 245 such that neighboring lenses, indicated with line 246, in this array would have to overlap. This is achieved by constructing the array of weaved lenses such that the array has piecewise alteration of lens segments of the overlapping neighboring lenses such as to result in lens surface 247. Note that the overlapping lenses are in fact imaginary lenses that would provide full illumination of the selected beam as indicated above. Some parts of the lens surface of the actual array of weaved lenses coincide with the lens surfaces of the overlapping ‘imaginary’ lenses, while others do not. It will be clear that if not full illumination is to be achieved the lens surface can be adjusted according to the above principle such as to achieve this effect.

Possible non uniform light intensity across the converging beam may be adjusted by adjusting the light intensity of the parallel beams such that it counteracts such non-uniformities. Filters or adjusted backlight lens shape may be used to this end.

Conveniently, the array of weaved lenses may be integrated with the backlight lenses to provide the entire converging beam capability to the collimating backlight.

### BASIS FOR DIVISIONAL APPLICATION

If the collimating backlight is arranged such that it provides light beams, either parallel or convergent, that have an extent of collimation that it is at least sufficient to ensure that the complete light beams fall within the beam transferred into the views by the optical arrangement of the autostereoscopic display, then the selection barrier may in principle be omitted from the barrier arrangement. Thus, for example if the parallel light beams of the collimating backlight exactly match the parallel beams entering the lenses 120 of FIG. 4, then the barrier 80 may be omitted. Similarly if the beams would be convergent such as to match the beams passing the pixel array of FIGS. 13 and 14, the barriers 80 could be omitted without loss of effect.

The invention provides a multi-view display. In particular, the single-cone stereo region has at least 3 different 2D views (corresponding to two 3D viewing positions). Preferably, the stereo region has at least 5 2D views, more preferably 9 or more, and even possibly 15 or more views. The number of 2D views will be selected based on the desired compromise between the resolution and the look-around impression which can be achieved with more views, as well as the desired width of the stereo viewing region (as the 2D views are separated by 0.5 to 3 degrees for example).

Although the description above has concentrated on a “light valve” display like an LCD, the invention also applies to emissive type of displays like e.g. organic LED (OLED) displays. In the latter case the light present within the glass of the display is not confined to a 2×42° top-angle cone, but the whole angular space is occupied. All embodiments above can be used, with one modification: that the barrier apertures must have an air gap as shown in FIG. 9c. The air gap ensures that the light from one pixel can only pass through one barrier aperture. The air gap may be replaced with any other gap having the same effect as will be understood. All other barrier apertures are blocked by total internal reflection. The relation between the barrier pitch p and the barrier-pixel distance d must be the same as shown in FIG. 5. An air-gap aperture may—but need not—be used for a light valve display like an LCD.

Some examples above have been shown having only one main lens (lens 120). In practice, as in the actual design shown in FIG. 15, it can be beneficial to split the main lens into two refractive surfaces. This may have technological reasons or optical quality reasons. Moreover, in case of one main lens, the lens might be formed directly on the glass between barrier and lens. As far as the definition of the pixel-lens distance, dₗ, is concerned, this can be considered as the smallest possible distance from the pixel plane to a part of the lens (or lens stack) for FIGS. 13 and 14. For FIG. 12 dₗ can be considered as the largest possible distance from the pixel plane to a part of the lens.

In the Figures, the viewing area (i.e. the single cone) has been shown as covering substantially the full 180 degree range of output angles. However, this is not essential. For example, dark bands may be present at steep angles, so that the viewing cone is more limited. For example the central 120 degrees may define the viewing zone (field of view) for the display, and 30 degrees at each side can be dark zones.

Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. The mere fact that certain measures are recited in mutually different dependent claims does not indicate that a combination of these measured cannot be used to advantage. Any reference signs in the claims should not be construed as limiting the scope.

1. An autostereoscopic display device having a field of view in a lateral and vertical direction, the autostereoscopic display comprising:
a display panel (86);
a barrier arrangement (80) comprising an array of openings (82), spaced from the display panel (86), wherein the angle of light paths between the display panel (86) and the barrier arrangement (80) is limited to a first range at each side of a direction normal to the display panel;
a lens arrangement with at least one lens (90) associated with each barrier arrangement opening (82),
wherein the angle of light paths to the field of view of the display device is limited to a second range at each side of the direction normal to the display panel, with the second range greater than the first range,
wherein the display panel is adapted to provide a plurality of views to different lateral viewing directions, wherein at least a portion of the field of view has autostereoscopic output, and wherein the portion having autostereoscopic output has no repetition of individual 2D views and comprises at least three individual 2D views.

2. An autostereoscopic display device as claimed in claim 1, wherein the display panel (86) comprises an array of display pixels, and the barrier arrangement (80) is arranged such that light from a pixel reaches only one barrier opening.

3. An autostereoscopic display device as claimed in claim 1, wherein the lenses (90) of the lens arrangement are positioned at the openings (82) of the barrier arrangement.

4. An autostereoscopic display device as claimed in claim 3, wherein the radius (R) of each lens (90) of the lens arrangement is between 0.2 and 0.5 times the spacing (D) between the barrier arrangement and the display panel.

5. An autostereoscopic display device as claimed in claim 1, wherein all of the field of view has autostereoscopic output.

6. An autostereoscopic display device as claimed in claim 1, wherein a central portion of the field of view has autostereoscopic output, and lateral portions of the field of view have 2D output.

7. An autostereoscopic display device as claimed in claim 6, wherein the individual 2D views of the central portion of the field of view are more closely positioned than the 2D views in the lateral portions of the field of view, wherein the individual 2D views of the central portion are preferably separated by 0.5 to 3 degrees.

8. An autostereoscopic display device as claimed in claim 7, wherein the lens arrangement (120) is provided between the display panel (86) and the barrier arrangement (80), and wherein the ratio of the distance (dₗ) of the lenses (120) from the display panel (86) to the distance (d_{b}) of the barrier arrangement (80) from the display panel (86) is in the range 0.3 to 0.6.

9. An autostereoscopic display device as claimed in claim 7, wherein the barrier arrangement (80) is provided between the display panel (86) and the lens arrangement (120), with each lens element receiving all the light from a respective barrier opening.

10. An autostereoscopic display device as claimed in claim 9, wherein:
the ratio of the distance (dₗ) of the lenses (120) from the display panel (86) to the distance (d_{b}) of the barrier arrangement (80) from the display panel (86) is in the range 1.5 to 2.5; and/or
the ratio of the distance (d_{b}) of the barrier arrangement (80) from the display panel (86) to the pitch of the openings (82) of the barrier arrangement (80) is in the range 0.3 to 0.6.

11. An autostereoscopic display device as claimed in claim 9, wherein the lens elements have a central portion which receives light only from one barrier opening, and shared edge portions which receive light from two adjacent barrier openings.

12. An autostereoscopic display device as claimed in claim 11, wherein the ratio of the distance (dₗ) of the lenses (120) from the display panel (86) to the distance (d_{b}) of the barrier arrangement (80) from the display panel (86) is in the range 2.5 to 3.5.

13. An autostereoscopic display device as claimed in claim 11, wherein the lens elements (120) comprise a stack of two lens sub-elements.

14. An autostereoscopic display device as claimed in claim 1, further comprising additional lens elements (122) at the openings of the barrier arrangement (80).

15. An autostereoscopic display according to claim 1 wherein the display panel comprises a spatial light modulator and a backlight for providing light to the spatial light modulator wherein the backlight is a collimated backlight providing collimated light to the spatial light modulator.

16. An autostereoscopic display according to claim 15 wherein the collimated light is parallel or convergent such that it is limited to at least the first range at each side of a direction normal to the display panel.

17. An autostereoscopic display according to claim 16, comprising an array of weaved lenses in between the display panel and the light sources of the collimating backlight for providing a converging, collimated beam of light to the display panel such that at the plane of the spatial light modulator there are no regions in between neighboring converging beams that are not illuminated by at least one beam.

18. An autostereoscopic display device as claimed in claim 1, further comprising a second barrier arrangement (130) comprising an array of openings, with the said barrier arrangement (80) and the second barrier arrangements between the display panel (86) and the lens arrangement (120), wherein the second barrier arrangement has wider openings than the first barrier arrangement.

19. An autostereoscopic display device as claimed in claim 18, wherein the display panel comprises a pixilated display, wherein for at least some pixels, within the first range of angles the pixel output is projected to at least two barrier openings of the barrier arrangement, and wherein the second barrier arrangement blocks light such that the light from pixel passes through only one of the second barrier arrangement openings.

20. A device as claimed in claim 1, wherein the barrier arrangement comprises at least one transparent slab, wherein the slab is shaped with a cross section in the shape of a rectangle with cut-outs, wherein the cut-outs are positioned in areas outside the regions to which the light paths between the display panel and the barrier arrangement are limited.

21. A collimating backlight comprising one or more light sources, and an array of weaved lenses for providing a plurality of convergent beams of light directed into one and the same direction.
